(19) United States
(12) Patent Application Publication
(10) Pub. No.: US 2004/0197363 A1
(43) Pub. Date: Oct. 7, 2004

(54) Coated granular material and method for production thereof

(76) Inventors: Reinhard Winter, Wulfrath (DE); Christian Priebe, Wulfrath (DE); Peter Kuhlmann, Wulfrath (DE)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/478,823

(22) PCT Filed: May 27, 2002
(86) PCT No.: PCT/EP02/05813

(30) Foreign Application Priority Data
May 30, 2001 (DE) 101 26 360.0

(51) Int. Cl. A01N 25/12; A01N 25/00

(52) U.S. Cl. 424/405; 504/367

(57) ABSTRACT

The invention relates to a coated granular material wherein the coating comprises the reaction product of (A) an acid-modified fatty (acid) component and (B) an epoxide component. The invention furthermore relates to a method for the preparation of coated granular materials comprising the steps (a) providing a granular material, (b) providing a coating material, comprising (A) an acid-modified fatty (acid) component and (B) an epoxide component, (c) adding of the coating material to the provided granular material, (d) generating a coating on the granular material, and (e) optionally repeating steps (c) and (d).

The present invention relates to a coated granular material, wherein the coating comprises the reaction product of (A) an acid-modified fatty (acid) component and (B) an epoxide component, as well as to a method for its preparation.

It is generally known to provide water-soluble materials with a cover or boating that is water-permeable but water-insoluble or difficult to be dissolved in water in order to decrease their dissolution rate and thus extend the duration of their effect. This method has gained particular importance in the field of fertilizers.

In the past, different coating materials have been suggested.

The document DE-A-1 242 573 describes a process for encapsulating granulates by spraying them with a liquid coating agent. A copolymerisate of dicyclopentadiene with drying or semidrying oils is suggested as coating agent. However, carrying out this process requires diluting the coating agent with a volatile solvent to provide a free-flowing consistency in order to allow spraying onto the granulate. The added solvent has to be removed during the process at high temperatures. This results in the release of combustible vapors which are harmful to the health. Furthermore, due to drying the time required for a coating process is unfavorably prolonged. On the whole, both the heating and the cooling processes require a very high amount of energy. The release of vapors furthermore necessitates a complicated cleaning process of the exhaust gas.

EP-A-0 230 601 describes a method for producing a water-permeable cover on water-soluble granular materials by coating with a synthetic resin. For this purpose, a coating substance is used which comprises a polyisocyanate and a polyol component from a condensation product of phenols and aldehydes, a plasticizer containing hydroxyl groups and optionally a diluent containing hydroxyl groups. The coating substance is cured with an amine as a catalyst. While this method can be carried out at relatively low temperatures, the amines used therein are characterized by a low boiling point and an extremely unpleasant and intensive odor. Therefore, this method as well requires a very thorough, technically very complex and thus also very expensive cleaning of the exhaust gas.

U.S. Pat. No. 3,259,482 describes fertilizer granulates having a water-insoluble resin as a coating. The coating is obtained from an epoxidized compound, for example epoxidized fats or epoxidized fatty acid esters and a polyester curing agent. The polyester component is the esterification product of a polyfunctional alcohol and a polyfunctional carboxylic acid. However, for coating the granulate, the resin has to be dissolved in a rapidly drying solvent which has to be removed later on in the process.

WO 96/41779 relates to covered fertilizer granulates that are covered with an ethylene copolymerisate having carboxyl groups, wherein the carboxyl groups can also be present in the form of their alkali, alkaline earth or ammonium salts, wherein the ethylene copolymerisate having carboxyl groups is comprised of a) 75 to 90 wt.-% ethylene and b) 10 to 25 wt.-% of an α-olefinically unsaturated C₃-C₈ alkyl carboxylic acid, and wherein such covered fertilizer granulates comprising a crop protection agent are excluded. The copolymerisates are applied to the fertilizer granulate in the form of an aqueous solution or an aqueous dispersion. This way, the use of organic solvents that are potentially harmful for health can be avoided. However, this process has the disadvantage that the water-soluble fertilizer granulate can partially dissolve when the aqueous solution or dispersion of the covering material is applied. For this reason, only a limited amount of the covering material can be added per moiety of time during this process. At the same time, it has to be ensured that the water can evaporate quickly in order to avoid complete dissolution of the granulate. Therefore, this process as well requires a large amount of energy and a technically complex process control in order to remove the water added during the process as quickly as possible.

It is therefore the object of the present invention to provide a coated granular material and a method for coating granular materials which does not require the use of organic and aqueous solvents, nor low-boiling additives, and wherein no low-boiling by-products are formed which necessitate a complicated cleaning of the exhaust gas and a complex process control. The method should result in a rapid coating of the granular material, wherein the coating should quickly become non-tacky and the covered material should quickly become free-flowing. The coating material should allow as quickly and as uniformly a wetting of the material to be coated as possible and be able to be applied thereto in very thin layers. The method should furthermore allow a trouble-free repetition of the coating process at short intervals.

The coating itself should meet different technical requirements: The coverings should be permeable to water or water vapor (in both directions) and allow a controlled and uniform release of the substance dissolved from the granular product to the outside. Furthermore, the covering should not be too brittle but should exhibit a certain elastic strength in order to avoid bursting during storage, application or transport. Preferably, the coating should be biodegradable after the duration of the material's effect has ended.

This object was achieved by the surprising finding that by reacting an acid-modified fatty (acid) component with an epoxide component, a coating material can be provided which meets the requirements listed above. Surprisingly, the coating material of the present invention exhibits the necessary properties even without the addition of organic solvents or water.

Thus, the subject-matter of the present invention is a coated granular material wherein the coating comprises the reaction product of (A) an acid-modified fatty (acid) component and (B) an epoxide component.

The subject matter of the invention is furthermore a method for preparing a coated granular material comprising the steps (a) providing a granular material, (b) providing a coating material, comprising (A) an acid-modified fatty (acid) component and (B) an epoxide component, (c) adding of the coating material to the provided granular material, (d) generating a coating on the granular material, and (e) optionally repeating steps (c) and (d).

The granular material to be coated is not critical. Basically, all granular materials can be coated by means of the present method. The granular material can for example be selected from asymmetrically shaped granular materials (granulates) or symmetrically shaped granular materials (pellets). Typical pellets can for example have the shape of a sphere, a rod, a cylinder or an ellipsoid. Typical granulate particles include asymmetrical aggregates of powder particles, whole crystals, crystal fragments or particles, or other fragments. The granular material can be porous or non-porous.

The particle size of the granular materials to be coated is not critical, either. It can for example be 0.5 to 10 mm (longest average diameter), with an average particle size in the range of 1 to 5 mm being preferred.

The method is of particular importance for the coating of water-soluble granular materials or such granular materials having a water-soluble portion or being impregnated with a water-soluble substance. Preferred granular materials to be covered are therefore selected from entirely or partially water-soluble granular materials. Examples of such materials include agrochemicals such as fertilizers, crop protection agents, insecticides, fungicides, soil conditioners, drying agents or mixtures thereof.

Suitable fertilizers that are suitable for coating are known granulates or pellets of organic and mineral fertilizers as well as mixtures thereof. Mononutrient or multinutrient fertilizers can for example be used which comprise nutrients such as nitrogen, potassium or phosphorus in the form of their salts or oxides alone or in combination. Examples thereof include NP, NK, PK or NKP fertilizers such as lime ammonium nitrate, ammonium sulfate, ammonium sulfate nitrate, calcium cyanamide or urea. In addition to the main components mentioned above, the fertilizer granulates can also comprise salts of trace elements such as magnesium, iron, manganese, copper, zinc, molybdenum and/or boron in small amounts, usually in amounts of 0.5 to 5 wt.-%. Suitable organic fertilizers include for example guano, fish meal, bone meal or lignin.

According to the present invention, even highly water-soluble or hygroscopic materials can be used as granular material to be coated, e.g. drying agents such as phosphorus pentoxide or calcium chloride. Due to the coating too fast a deliquescence in a humid environment can be prevented.

The covering of the granulates according to the present invention comprises the reaction product of an acid-modified fatty (acid) component (A) and an epoxide component (B).

The term “fatty (acid) component” as used in the present invention comprises both fatty components such as natural and synthetic triglycerides and fatty acid components such as fatty acids and fatty alcohols derivatized at the carboxyl moiety.

The term “carboxylic acid group” or “carboxylic acid moiety” as used in the following refers to the carboxyl group of a fatty acid, while the term “fatty acid group” or “fatty acid moiety” refers to the hydrocarbon group of a fatty acid.

The term “acid-modified” describes such originally unsaturated compounds into which one or more acid functionalities have been introduced by reacting the unsaturated moieties with unsaturated carboxylic acids or carboxylic acid anhydrides. It is for example known to introduce acid functionality into unsaturated resins by way of a subsequent reaction (e.g. Diels-Alder reaction) with unsaturated carboxylic acids or carboxylic acid anhydrides or by copolymerization with the unsaturated monomer forming the resin.

Thus, in the present invention, an acid-modified fatty (acid) component (A) is an adduct obtainable by reacting

(A-i) a fatty or fatty acid component which is at least mono-unsaturated in the fatty acid group with

(A-ii) an at least mono-unsaturated carboxylic acid component or carboxylic acid anhydride component.

Basically, all natural or synthetic triglycerides or esters of other polyvalent alcohols with fatty acids, but also fatty acids or carboxylic acid derivatives of fatty acids or fatty alcohols and their derivatives can be used as fatty (acid) component (A-i), as long as they have at least one double bond in the fatty acid group. The unsaturated fatty (acid) component should comprise at least one double bond, but it can also comprise several. In the present invention, the configuration of the double bond(s) is not essential. The double bond(s) in the fatty acid portion can be of a cis- or a trans-configuration. If the unsaturated fatty acid group has more than one double bond, they can be conjugated or non-conjugated.

In order to allow a polymeric cross-linking reaction with the epoxide component (B) later on, the average double bond functionality of the fatty (acid) component (A-i) should be at least 2, preferably 3.0 to 9.0.

Such fatty (acid) components (A-i) having a chain length of 3 to 24 carbon atoms, preferably 10 to 22 carbon atoms, in the fatty acid portion are preferred.

Several different forms of component (A-i) are suitable for preparing the acid-modified fatty (acid) component (A).

The fatty acid component (A-i) can for example be provided in the form of natural or synthetic triglycerides.

In this connection, the distribution of the double bond(s) in the triglyceride is not essential. For example, triglycerides having only one fatty acid with at least two double bonds wherein the other two fatty acids can be saturated or unsaturated are suitable. However, the double bonds can also be distributed in the fatty acid groups.

In a preferred embodiment, component (A-i) is provided in the form of natural fats and oils. Suitable substances therefor include for example linseed oil, hempseed oil, rape-seed oil, sunflower oil, cottonseed oil, castor oil, soybean oil, peanut oil, coconut butter, palm kernel oil, train oil, fish oil, lard oil, tall oil, lard, beef suet, cashew nut oil, palm oil or mixtures thereof.

Natural oils and fats are present as a mixture of different triglycerides. Accordingly, a natural fat or oil can also contain triglycerides that only have saturated fatty acid groups. This portion per se does not interfere with the reaction with the carboxylic acid moiety to form component (A) nor with the reaction of components (A) and (B) later on. If desired, this portion can be separated. However, in a preferred embodiment, no separation takes place. Preferably, the amount of saturated triglycerides should not exceed 15%, preferably 12%, and more preferably 10%, based on the total amount of triglycerides. Therefore, according to the present invention, such fats and oils are preferred that have as high an amount of unsaturated fatty acids as possible. The amount of unsaturated fatty acids can be determined by means of known methods with the help of the iodine number.

In addition to natural and synthetic glycerin fatty acid esters, unsaturated esters of other polyalcohols with fatty acids are also suitable as fatty (acid) component (A-i). Saturated aliphatic alcohols with at least two, preferably two to six, hydroxyl groups per molecule and 2 to 20, preferably 2 to 6, carbon atoms can be used as polyvalent alcohols. Specific examples are ethylene glycol, diethylene glycol, propylene glycol, dipropylene glycol, neopentyl glycol, glycerol, trimethylol propane, pentaerythritol, cyclohexane diol, threitol, erythritol and sorbitol. In these compounds, the hydroxyl groups can be fully or only partially esterified with fatty acids. The fatty acid groups can be the same or different from each other.

In another embodiment, the fatty (acid) component (A-i) can be provided in the form of at least mono-unsaturated, preferably di-unsaturated fatty acids and their derivatives. For this purpose, branched or straight-chain unsaturated fatty acids or fatty acid derivatives or mixtures thereof can be used.

Fatty acid derivatives usually refer to such compounds wherein the carboxylic acid moiety of the fatty acid has been chemically modified. The carboxylic acid moiety can for example be present as an ester or an amide or be reduced to an alcohol wherein the alcohol function can either be free or present in the form of an ester or ether.

Compounds of the general formula

R—CO—OR¹ (I)

can for example be used as fatty acid esters, wherein R is a branched or unbranched hydrocarbon group with 3 to 24 carbon atoms, preferably 8 to 20 carbon atoms, having at least one, preferably two, double bond(s), and R¹ is a straight-chain or branched alkyl group with 1 to 21, preferably 1 to 4, carbon atoms.

Compounds of the general formula

R—CO—NR²R³ (II)

can for example be used as fatty acid amides, wherein R is a branched or unbranched hydrocarbon group with 3 to 24 carbon atoms, preferably 8 to 20 carbon atoms, having at least one, preferably two, double bond(s), and R² and R³ independently represent a hydrogen atom or a branched or unbranched C₁-C₁₂, preferably C₁-C₆, alkyl group.

Suitable fatty alcohols and fatty alcohol derivatives are for example those of the general formula

R-O—R⁴ (III)

wherein R is a branched or unbranched hydrocarbon group with 3 to 24 carbon atoms, preferably with 8 to 20 carbon atoms, having at least one, preferably two, double bonds, and R⁴ represents a hydrogen atom or a branched or unbranched C₁-C₁₂, preferably C₁-C₆, alkyl group or a group —(CO)R⁵, wherein R⁵ is a branched or unbranched C₁-C₁₂, preferably C₁-C₆, alkyl group.

Ethers of fatty alcohols with polyols, e.g. with glycerol, trimethylol propane, pentaerythritol or propanediol can also be used as fatty alcohol ethers.

Such fatty acids and fatty acid derivatives wherein the group R in formulas (I) to (III) represents a natural, at least mono-unsaturated, preferably di-unsaturated fatty acid group, e.g. a palmitoleic acid group, an oleic acid group, an erucic acid group, a sorbic acid group, a linoleic acid group or a linolenic acid group, are especially preferred.

The above-mentioned compounds (A-i) can be used individually or in admixture.

Suitable carboxylic acid components (A-ii) are unsaturated carboxylic acids or carboxylic acid anhydrides having at least one double bond. The position of the double bond with respect to the acid or anhydride moiety is not critical. However, especially favorable results are obtained when the double bond is in a conjugated position to the carboxylic acid or anhydride moiety. The carboxylic acid component (A-ii) can be aliphatic, mono-unsaturated, poly-unsaturated or aromatic. A single carboxylic acid component or mixtures of different carboxylic acid components (A-ii) can be used for preparing the acid-modified fatty (acid) component (A).

In a preferred embodiment of the present invention, carboxylic acid anhydrides of dicarboxylic acids that have at least one, preferably one to three, and especially preferred one double bond and typically comprise at total of 4 to 15, preferably 4 to 8, carbon atoms are used for preparing component (A). Of these carboxylic acid anhydrides, those having at least one double bond in a conjugated position to the anhydride moiety are especially preferred.

Suitable unsaturated carboxylic acids are for example maleic acid, acrylic acid, methacrylic acid, phthalic acid or fumaric acid.

Suitable unsaturated carboxylic acid anhydrides are maleic acid anhydride, itaconic acid anhydride, phthalic acid anhydride, naphthaline-1,8-dicarboxylic acid anhydride, nadic acid anhydride or mixtures thereof. It is especially preferred that the carboxylic acid component (A-ii) be selected from maleic acid anhydride, itaconic acid anhydride, phthalic acid anhydride and mixtures thereof.

Especially suitable compounds for component (A) are adducts of maleic and/or phthalic acid anhydride and sunflower oil, soybean oil or linseed oil, or mono- or poly-unsaturated fatty acid esters of simple alcohols, preferably C₁-C₄ alkanols, wherein the fatty acid group has a chain-length of 5 to 24 carbon atoms, preferably 10 to 22 carbon atoms.

The epoxide component (B) is not particularly restricted. Both compounds with terminal epoxide groups and compounds with internal epoxide groups can be used as epoxide component. Preferably, the epoxide component should have an average epoxide functionality of at least two epoxide groups per molecule in order to allow the formation of a polymeric network. The molecular weight of the epoxide compounds is typically in the range of 200 to 3,000. The epoxide oxygen content is usually between 1 and 20 wt.-%, preferably 5 and 15 wt.-%.

Examples of epoxide compounds with terminal epoxide groups are glycidyl ethers obtained from reacting compounds having hydroxyl groups and epichlorohydrin, e.g. epoxide resins on the basis of bisphenol-A or bisphenol-F, reaction products of epichlorohydrin and o-cresol or phenol novolaks, glycidyl ethers of polyols such as 1,6-hexanediol, trimethylolpropane, glycerol or polyglycerol.

Furthermore, compounds with terminal or internal epoxide groups obtained by the epoxidation of olefins or other unsaturated compounds with an epoxidation agent, e.g. performic acid, are also suitable. In principle, reaction products of glycidol and epoxides, isocyanates or other compounds are suitable as well.

Additional suitable compounds with internal epoxide groups include fats and oils that have been “epoxidized” (at unsaturated moieties originally present in the fatty acid group) as well as epoxidized fatty acid derivatives. Suitable fatty acid derivatives include epoxidized esters of fatty acids with mono- or polyvalent alcohols, epoxidized fatty acid amides, and esters or ethers of epoxidized fatty alcohols.

Examples of epoxidized fatty acid esters are esters of fatty acids that have been epoxidized (at unsaturated moieties originally present in the fatty acid group) with mono- or polyvalent alcohols. Suitable monovalent alcohols are for example branched or unbranched C₁-C₆ alkanols, such as methanol, ethanol, iso- and n-propanol, iso- and n-butanol. Suitable polyvalent alcohols comprise saturated aliphatic alcohols with at least two, preferably two to six hydroxyl groups per molecule and 2 to 20, preferably 2 to 6, carbon atoms. Specific examples are ethylene glycol, diethylene glycol, propylene glycol, dipropylene glycol, neopentyl glycol, glycerol, trimethylolpropane, pentaerythritol, cyclohexanediol, threitol, erythritol and sorbitol.

Examples of epoxidized fatty acid amides are amides of epoxidized fatty acids and NH₃ or simple primary or secondary amines and diamines having e.g. 1 to 12, preferably 1 to 6, carbon atoms, such as methyleneamine, dimethyleneamine, methylethylamine, methylenediamine or diethyleneamine.

As epoxidized fatty alcohol derivatives, esters of epoxidized fatty alcohols and simple C₁-C₇, preferably C₂-C₇ carboxylic acids can be mentioned, such as acetic acid, butyric acid or benzoic acid, or ethers of epoxidized fatty alcohols with mono- or polyvalent alcohols. Suitable monovalent alcohols are for example branched or unbranched C₁-C₆, preferably C₁-C₄ alkanols, such as methanol, ethanol, iso- and n-propanol, iso- and n-butanol. Suitable polyvalent alcohols comprise saturated aliphatic alcohols with at least two, preferably two to six hydroxyl groups per molecule and 2 to 20, preferably 2 to 6, carbon atoms. Specific examples are ethylene glycol, diethylene glycol, propylene glycol, dipropylene glycol, neopentyl glycol, glycerol, trimethylolpropane, pentaerythritol, dipentaerythritol, cyclohexanediol, threitol, erythritol and sorbitol.

Especially suitable epoxidized fatty acid derivatives have a chain length of 5 to 24, preferably 10 to 22, carbon atoms in the fatty acid portion.

Polymeric epoxide compounds such as epoxidized polyoctylene and epoxidized polyisoprene are also suitable as epoxide component (B). Mixtures of different epoxide components can be used as well.

Bisphenol-A and bisphenol-F epoxide resins, glycidyl ethers of trimethylolpropane and glycerol, epoxidized soybean, linseed, rape-seed or hempseed oils and mixtures thereof are especially preferred.

For preparing the coated granular material, the granular material is first provided and optionally preheated to a temperature of 50 to 250° C., preferably 80 to 150° C., before the coating material is added.

The acid-modified fatty (acid) component (A) is mixed with the epoxide component (B) to provide the coating material. If desired, further additives can be added to the coating material, such as catalysts, modifying agents, fillers or other components that are advantageous for the specific application of a certain coated granular material.

In the method according to the present invention, the easiest way to carry out the coating process is in a rotating vessel, e.g. a drum that is preferably equipped with an edge scraper.

The coating material can be added to the granular material continuously or in portions. The portions added can comprise identical or different amounts of coating material. Preferably, the next portion of coating material should be held back until the portion of coating material added in the previous step has been distributed as uniformly as possible on the granular material. Depending on the temperature, amount and type of the coating material and the granulate used, this time period can for example comprise 2 to 10 minutes. Continuous addition can typically take from 15 to 60 minutes. It is especially preferred to provide the coating material without the addition of solvents or water.

The amount of coating material added is not essential. However, from an economic point of view, it is desirable to use as small an amount of coating material as possible. At the same time, however, the amount should be large enough to provide a functioning covering on the granulate. The coating material is usually used in an amount of about 3 to 40 wt.-%, preferably 5 to 15 wt.-%, based on the granular material to be covered. Moreover, the release rate of the substance from the coated granules can be controlled via the amount of coating material.

It is preferred to agitate the coated granular material throughout the entire process. This can for example be done by stirring or shaking. However, other application methods for carrying out the process are conceivable as well. For instance, the agitation of the granular material can be carried out by means of a fluidized-bed process. Here, a fluidized bed of the granular material is generated by means of a fluidizing gas and the coating material is subsequently added to the fluidized bed. Such fluidized-bed application processes are for example described in U.S. Pat. No. 5,211,985.

The curing of the coating material can for example be controlled by increasing the temperature or adding catalysts. The process is usually carried out at a temperature of 50 to 250° C., preferably 80 to 150° C. The catalysts typically used in the technical field for the catalysis of reactions between epoxide and acid/anhydride moieties are suitable catalysts. They include nitrogen-containing catalysts such as tertiary amines, imidazoles and their derivatives, polyimidazoles and copolymers of imidazole and suitable comonomers, dicyanamide, quaternary ammonium compounds, boron trifluoride derivatives, as well as calcium or magnesium salts of fatty acids, such as calcium or magnesium stearate.

The coating of the granular material can be comprised of more than one layer of the cured coating material (reaction product) and the layers can have the same or different thicknesses and each of them can partially or fully cover the material. However, on the whole, the covering should cover the material as completely as possible in order to prevent too early or too rapid a release of the granular material or the active substance contained in the granular material.

The coating is permeable to water or water vapor in both directions. Therefore, the coated granular materials of the present invention are characterized by a uniform release of the active substance. Depending on the thickness and type of the covering material, a fertilizer granulate can for example be produced whose effectiveness can last from one month up to two years. Furthermore, the coating has favorable mechanical properties. Another advantage of the coated granular materials according to the present invention is that the covering material is mainly based on renewable raw materials and is therefore preferable from an ecological point of view.

The method is suitable for coating practically every kind of granular material. However, the particular advantages of the method are especially evident in the case of completely or partially water-soluble granular materials. The method can be carried out at relatively low temperatures and in the absence of undesired solvents.

### EXAMPLES

The invention is described in the following examples which do not restrict the invention in any way.

1. Preparation of Component (A)=Acid-Modified Fatty (Acid) Component, Hereinafter Referred to as “Curing Agent”

Curing Agent 1: Maleic Acid Anhydride/Soybean Oil Adduct

1829 g soybean oil and 640 g maleic acid anhydride were weighed in to a 4-liter three-neck flask equipped with a reflux condenser, thermometer and KPG stirrer and heated to 200° C.+/−5° C. in a nitrogen atmosphere under stirring. The reaction mixture was held at this temperature for 3 hours. A viscous, clear brown product was obtained.

Curing Agent 2: Maleic Acid Anhydride/Linseed Oil Adduct

1935 g refined linseed oil and 1065 g maleic acid anhydride were weighed in to a 4-liter three-neck flask equipped with a reflux condenser, thermometer and KPG stirrer and heated to 200° C. +/−5° C. in a nitrogen atmosphere under stirring. The reaction mixture was held at this temperature for 7 hours. A viscous, clear brown product was obtained.

Curing Agent 3: Maleic Acid Anhydride/Linseed Oil/Rape-Seed Fatty Acid Adduct

1500 g refined linseed oil, 225 g rape-seed fatty oil and 775 g maleic acid anhydride were weighed in to a 4-liter three-neck flask equipped with a reflux condenser, thermometer and KPG stirrer and heated to 200° C.+/−5° C. in a nitrogen atmosphere under stirring. The reaction mixture was held at this temperature for 4 hours. A viscous, clear brown product was obtained.

2. Preparation of Coated Granulates

The coatings were carried out in a rotating drum. The speed was adjusted such that sufficient mixing of the product to be coated was guaranteed. The granulate was agitated during the entire coating process.

A commercially available untreated NPK mineral fertilizer with a grain size of 3 to 6 mm was used for coating. Prior to coating, the fertilizer was preheated in an oven to about 120° C.

### Example 1

A mixture of 23.0 wt.-% trimethylol propane triglycidyl ether and 77 wt.-% curing agent 1 was prepared in a beaker. The coating composition, a total of 15 wt.-% based on the fertilizer, was added to the product to be coated in four equal portions whereby the next portion was not added until the previously added portion had cured. The coating period was a total of about 20 to 30 minutes. The still hot covered fertilizer was not tacky, did not stick together and was free-flowing/-running. The curing temperature was 150° C.

### Example 2

A mixture of 31.0 wt.-% epoxidized linseed oil and 60 wt.-% curing agent 2 was prepared in a beaker. The coating composition, a total of 10 wt.-% based on the fertilizer, was added to the product to be coated in five equal portions whereby the next portion was not added until the previously added portion had cured. The coating period was a total of about 20 to 30 minutes. The curing temperature was 150° C. The still hot covered fertilizer was not tacky, did not stick together and was free-running.

### Example 3

A mixture of 29.0 wt.-% epoxidized linseed oil, 70.5 wt.-% curing agent 3 and 0.5 wt.-% 4-methylimidazole was prepared in a beaker. The coating composition, a total of 10 wt.-% based on the fertilizer, was added to the product to be coated in five equal portions whereby the next portion was not added until the previously added portion had cured. The coating period was a total of about 20 to 30 minutes. The curing temperature was 140° C.

The still hot covered fertilizer was not tacky, did not stick together and was free-running.

### Example 4

A mixture of 28.0 wt.-% epoxidized linseed oil, 8.0 wt.-% epoxidized trimethylolpropane trioleate, 63.0 wt.-% curing agent 2 and 1.0 wt.-% magnesium stearate was prepared in a beaker.

The coating composition, a total of 8.0 wt.-% based on the fertilizer, was continuously added to the product to be coated for a time period of about 15 minutes. Then heat-curing was conducted for 20 minutes. The curing temperature was 160° C.

The still hot covered fertilizer was not tacky, did not stick together and was free-running.

### Example 5

A mixture of 31.0 wt.-% epoxidized linseed oil and 69 wt.-% curing agent 2 was prepared in a beaker. The coating composition, a total of 8 wt.-% based on the fertilizer, was added to the product to be coated in seven equal portions whereby the next portion was not added until the previously added portion had cured. The coating period was a total of about 60 minutes. The curing temperature was 110° C.

The still hot covered fertilizer was not tacky, did not stick together and was free-running.

Determination of the Release of Active Substance

For determining the release of active substance, 12.5 g each of the coated fertilizers prepared in Examples 1 to 5 were added to 1250 g water and stored at 22° C. The amount of active substance that had dissolved was determined on the basis of the increase in electric conductivity. The amount of active substance that has dissolved can be determined by a comparison with uncoated basic fertilizer. The results are shown in Table 1.

TABLE 1
Amount of active substance in % that has dissolved [based on uncoated basic
fertilizer]

| | | | | | | Comparative |
|---|---|---|---|---|---|---|
| Time | Example 1 | Example 2 | Example 3 | Example 4 | Example 5 | Example |
| 24 h | 2.3 | 4.1 | 2.2 | 1.8 | 8.2 | 4.2 |
| 48 h | 12.1 | 18.3 | 11.1 | 12.2 | 29.2 | 14.3 |
| 1 week | 18.2 | 26.7 | 16.7 | 15.8 | 35.4 | 21.2 |
| 2 weeks | 23.8 | 41.3 | 22.1 | 19.1 | 50.5 | 30.0 |
| 3 weeks | 29.4 | 55.2 | 25.4 | 22.6 | 72.3 | 31.5 |
| 4 weeks | 34.8 | 60.5 | 29.8 | 24.2 | 89.2 | 37.5 |
| 6 weeks | 39.1 | 71.5 | 32.2 | 28.1 | 94.2 | 40.0 |

### COMPARATIVE EXAMPLE

A commercially available NPK fertilizer with an average grain size of 3 mm was used as the basic fertilizer. The fertilizer was covered with a coating material obtained from a polyisocyanate and a polyol component as described in Example 1 of EP-A-0 230 601.

1. A coated granular material, wherein the coating comprises the reaction product of (a) an acid-modified fatty (acid) component and (b) an epoxide component.

2. The coated granular material of claim 1, wherein the granular material is at least partially water-soluble.

3. The coated granular material of claim 1, wherein the coating is permeable to water or water-vapor, but is water-insoluble.

4. The coated granular material of claim 1, wherein the acid-modified fatty (acid) component is obtainable by reaction of
(A-i) a fatty (acid) component which is at least mono-unsaturated in the fatty acid group with
(A-ii) an at least mono-unsaturated carboxylic acid component or carboxylic acid anhydride component.

5. The coated granular material of claim 1, wherein the coating is composed of more than one layer of the reaction product, and the layers each have the same or different layer thicknesses and each can be partially or completely encapsulating.

6. The coated granular material of claim 1, wherein the granular material is selected from the group consisting of fertilizers, crop protection agents, insecticides, pesticides, fungicides, drying agents and mixtures thereof.

7. The coated granular material of claim 1, wherein the granular material has an average grain size of 0.5 to 10 mm diameter.

8. The coated granular material of claim 1, wherein the epoxide component (B) has an epoxide oxygen content of 1 to 20 wt.-%.

9. A method for the preparation of the coated granular material of claim 1, comprising the steps of:
(a) providing a granular material,
(b) providing a coating material, comprising (A) an acid-modified fatty (acid) component and (B) an epoxide component,
(c) adding of the coating material to the provided granular material,
(d) generating a coating on the granular material, and
(e) optionally repeating steps (c) and (d).

10. The method of claim 9, wherein in step (a) the granular material is provided in a form which is preheated to a temperature of 50 to 250° C.

11. The method of claim 9, wherein in step (b) the coating material is provided in a solvent-free form.

12. The method of claim 9, wherein step (d) comprises curing of the coating material.

13. The method of claim 9, wherein step (d) is carried out at a temperature of 50 to 250° C.

14. The method of claim 9, wherein the acid-modified fatty (acid) component is obtainable by reaction of
(A-i) a fatty (acid) component which is at least mono-unsaturated in the fatty acid group with
(A-ii) an at least mono-unsaturated carboxylic acid component or carboxylic acid anhydride component.

15. The method of claim 9, wherein the fatty (acid) component (A-i) is provided in form of natural fats and/or oils.

16. The method of claim 9, wherein the fatty (acid) component (A-i) is provided in form of unsaturated fatty acids or derivatives thereof.

17. The method of claim 9, wherein the component (A-ii) is selected from carboxylic acid anhydrides selected from the group consisting of maleic acid anhydride, itaconic acid anhydride, phthalic acid anhydride, naphthaline-1,8-dicarboxylic acid anhydride or nadic acid anhydride or from carboxylic acids selected from the group consisting of maleic acid, acrylic acid, methacrylic acid, phthalic acid or fumaric acid or mixtures thereof.

18. The method of claim 9, wherein the adding and/or the generating of the coating is carried out continuously.
